(19) United States
(12) Patent Application Publication
(10) Pub. No.: US 2009/0063402 A1
(43) Pub. Date: Mar. 5, 2009

(54) Method and System for Providing Medication Level Determination

(75) Inventor: Gary Hayter, Oakland, CA (US)

Correspondence Address: JACKSON & CO., LLP, 6114 LA SALLE AVENUE, #507, OAKLAND, CA, 94611-2802, US

(73) Assignee: Abbott Diabetes Care, Inc., Alameda, CA (US)

(21) Appl. No.: 12/199,819

(22) Filed: Aug. 28, 2008

Related U.S. Application Data
(60) Provisional application No. 60/969,588, filed on Aug. 31, 2007.

(51) Int. Cl. G06F 7/06; G06F 17/30

(52) U.S. Cl. 707/2; 707/3; 707/E17.017

(57) ABSTRACT

Method and devices for receiving one or more of a carbohydrate amount or a blood glucose information, performing a query function to retrieve from a pre-stored lookup table an insulin dosage amount associated with the received one or more of the carbohydrate amount or blood glucose information, and outputting the retrieved insulin dosage amount are provided.

### RELATED APPLICATION

The present application claims priority under 35 U.S.C. §119(e) to U.S. provisional application No. 60/969,588 filed Aug. 31, 2007, entitled “Method And System For Providing Medication Level Determination”, and assigned to the Assignee of the present application, Abbott Diabetes Care, Inc. of Alameda, Calif., the disclosure of which is incorporated herein by reference for all purposes.

### BACKGROUND

The present disclosure relates to analyte monitoring systems and health management systems. More specifically, the present disclosure relates to method and system for providing basal profile modification in analyte monitoring systems to improve insulin therapy in diabetic patients.

In data communication systems such as continuous, semi-continuous or discrete analyte monitoring systems for insulin therapy, analyte levels of a patient are monitored and/or measured, and the measured analyte levels are used for treatment. For example, real time values of measured analyte levels of a patient would allow for a more robust and accurate diabetes treatment. Moreover, a profile of a series of measured analyte levels of a diabetic patient can provide valuable information regarding the fluctuations and variations of the analyte levels in a diabetic patient. In turn, this type of information would be invaluable in establishing a suitable insulin therapy regimen.

Many diabetic patients that use an infusion device such as an infusion pump generally have a preset or pre-established basal profiles which are programmed or stored into the infusion device by the patient's physician or the patient herself. Indeed, based on several factors such as insulin sensitivity, the patient's physiology and other variable factors that effect the patient's analyte levels, the physician may tailor the basal profiles of the patient to be programmed into the infusion device such that the patient's analyte level is maintained within an acceptable range, and thus the patient is not going to experience hyperglycemia or hypoglycemia.

While physicians attempt to best determine the most suitable basal profiles for each diabetic patient using the infusion device, it is often difficult to attain the most suitable profiles to ensure the safe operating range of the infusion device while providing the patient with the most suitable level of insulin at all times when the patient is wearing and operating the infusion device.

Often, diabetics who use infusion pumps run basal profiles to maintain a steady level of insulin and also, supplement with additional bolus doses and/or temporary basals administered typically with the same infusion pumps. Various devices exist that enable the determination of the appropriate bolus to supplement the basal profiles. For example, prior to the ingestion of a large quantity of carbohydrates, the patient is able to calculate a carbohydrate bolus and administer the same with the infusion pump so that the intake of the carbohydrates does not adversely impact the patient's physiology. In addition, to compensate for high blood glucose level, a correction bolus may be calculated and administered.

Such devices are generally provided with functions that allow the users to enter certain parameters suitable or necessary for the bolus or insulin dosage calculation amount, and perform the actual calculation based on one or more of the entered parameters to derive at the appropriate bolus dosage amount.

### SUMMARY

In one aspect, there is provided method and apparatus for providing medication dosage level determination retrieved from lookup tables generated and stored based on the user entered values or parameters. In particular, in one aspect, method and devices for receiving one or more of a carbohydrate amount or a blood glucose information, performing a query function to retrieve from a pre-stored lookup table an insulin dosage amount associated with the received one or more of the carbohydrate amount or blood glucose information, and outputting the retrieved insulin dosage amount are provided.

### BRIEF DESCRIPTION OF THE DRAWINGS

FIG. 1 illustrates a block diagram of a data monitoring and management system for practicing one embodiment;

FIG. 2 is a block diagram of the transmitter unit of the data monitoring and management system shown in FIG. 1 in accordance with one embodiment;

FIG. 3 is a flowchart illustrating the process for monitoring analyte levels and determining modification to a current basal profile in accordance with one embodiment;

FIGS. 4A-4C illustrate a current basal profile, a monitored analyte level profile, and a modified basal profile recommendation respectively, in accordance with one embodiment; and

FIGS. 5-6 illustrate one aspect of bolus lookup table generation and retrieval in one embodiment.

### DETAILED DESCRIPTION

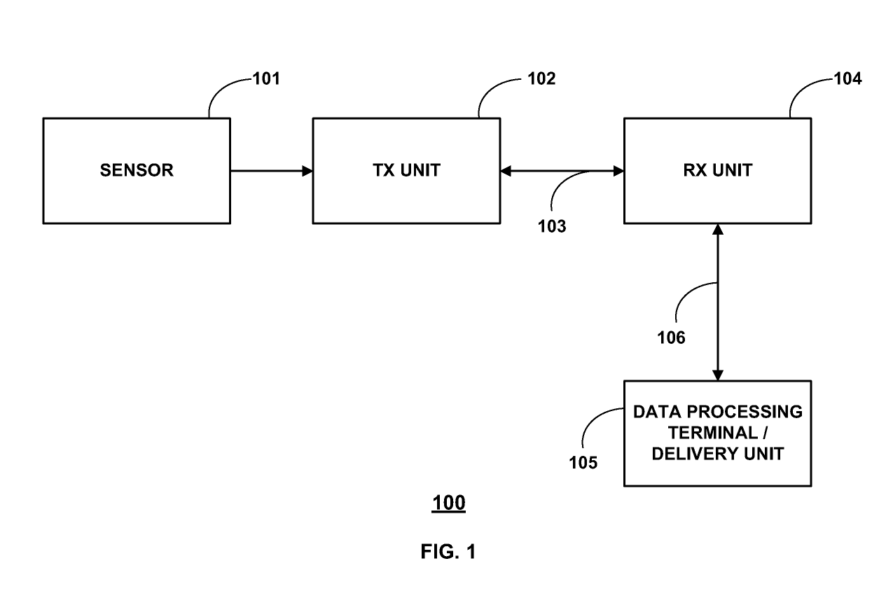

FIG. 1 illustrates a data monitoring and management system such as, for example, an analyte (e.g., glucose) monitoring and management system 100 in accordance with one embodiment of the present disclosure. The subject disclosure is further described primarily with respect to an analyte monitoring and management system for convenience and such description is in no way intended to limit the scope of the disclosure. It is to be understood that the analyte monitoring system may be configured to monitor a variety of analytes, e.g., lactate, and the like.

Indeed, analytes that may be monitored include, for example, acetyl choline, amylase, bilirubin, cholesterol, chorionic gonadotropin, creatine kinase (e.g., CK-MB), creatine, DNA, fructosamine, glucose, glutamine, growth hormones, hormones, ketones, lactate, peroxide, prostate-specific antigen, prothrombin, RNA, thyroid stimulating hormone, and troponin. The concentration of drugs, such as, for example, antibiotics (e.g., gentamicin, vancomycin, and the like), digitoxin, digoxin, drugs of abuse, theophylline, and warfarin, may also be monitored.

The analyte monitoring and management system 100 includes a sensor 101, a transmitter unit (Tx) 102 coupled to the sensor 101, and a receiver unit (Rx) 104 which is configured to communicate with the transmitter unit 102 via a communication link 103. The receiver unit 104 may be further configured to transmit data to a data processing terminal 105 for evaluating the data received by the receiver unit 104. Moreover, the data processing terminal in one embodiment may be configured to receive data directly from the transmitter unit 102 via a communication link 106 which may optionally be configured for bi-directional communication.

Only one sensor 101, transmitter unit 102, communication link 103, receiver unit 104, and data processing terminal 105 are shown in the embodiment of the analyte monitoring and management system 100 illustrated in FIG. 1. However, it will be appreciated by one of ordinary skill in the art that the analyte monitoring and management system 100 may include one or more sensor 101, transmitter unit 102, communication link 103, receiver unit 104, and data processing terminal 105, where each receiver unit 104 is uniquely synchronized with a respective transmitter unit 102. Moreover, within the scope of the present disclosure, the sensor 101 may include a subcutaneous analyte sensor, a transcutaneous analyte sensor, an implantable analyte sensor, or a noninvasive analyte sensor such as a transdermal patch or an optical sensor (for example, infrared sensor).

Moreover, within the scope of the present disclosure, the analyte monitoring system 100 may be a continuous monitoring system, or semi-continuous, or a discrete monitoring system. Additionally, within the scope of the present disclosure, the sensor 101 may include a subcutaneous analyte sensor or an implantable analyte sensor which is configured to be substantially wholly implanted in a patient.

In one embodiment of the present disclosure, the sensor 101 is physically positioned in or on the body of a user whose analyte level is being monitored. The sensor 101 may be configured to continuously sample the analyte level of the user and convert the sampled analyte level into a corresponding data signal for transmission by the transmitter unit 102. In one embodiment, the transmitter unit 102 is mounted on the sensor 101 so that both devices are positioned on the user's body. The transmitter unit 102 performs data processing such as filtering and encoding on data signals, each of which corresponds to a monitored analyte level of the user, for transmission to the receiver unit 104 via the communication link 103.

In one embodiment, the analyte monitoring system 100 is configured as a one-way RF communication path from the transmitter unit 102 to the receiver unit 104. In such embodiment, the transmitter unit 102 transmits the sampled data signals received from the sensor 101 without acknowledgement from the receiver unit 104 that the transmitted sampled data signals have been received. For example, the transmitter unit 102 may be configured to transmit the encoded sampled data signals at a fixed rate (e.g., at one minute intervals) after the completion of the initial power on procedure. Likewise, the receiver unit 104 may be configured to detect such transmitted encoded sampled data signals at predetermined time intervals. Alternatively, the analyte monitoring system 100 may be configured with a bi-directional RF (or otherwise) communication between the transmitter unit 102 and the receiver unit 104.

Additionally, in one aspect, the receiver unit 104 may include two sections. The first section is an analog interface section that is configured to communicate with the transmitter unit 102 via the communication link 103. In one embodiment, the analog interface section may include an RF receiver and an antenna for receiving and amplifying the data signals from the transmitter unit 102, which are thereafter, demodulated with a local oscillator and filtered through a band-pass filter. The second section of the receiver unit 104 is a data processing section which is configured to process the data signals received from the transmitter unit 102 such as by performing data decoding, error detection and correction, data clock generation, and data bit recovery.

In operation, upon completing the power-on procedure, the receiver unit 104 is configured to detect the presence of the transmitter unit 102 within its range based on, for example, the strength of the detected data signals received from the transmitter unit 102 or a predetermined transmitter identification information. Upon successful synchronization with the corresponding transmitter unit 102, the receiver unit 104 is configured to begin receiving from the transmitter unit 102 data signals corresponding to the user's detected analyte level. More specifically, the receiver unit 104 in one embodiment is configured to perform synchronized time hopping with the corresponding synchronized transmitter unit 102 via the communication link 103 to obtain the user's detected analyte level.

Referring again to FIG. 1, the data processing terminal 105 in one embodiment may be configured to include a medication delivery unit such as an infusion device including, for example, an insulin pump, and which may be operatively coupled to the receiver unit 104. In such an embodiment, the medication delivery unit 105 may be configured to administer a predetermined or calculated insulin dosage based on the information received from the receiver unit 104 and/or user directed programming entered into the medication delivery unit 105 or the receiver unit 104. For example, as discussed in further detail below, the medication delivery unit 105 in one embodiment may be configured to deliver insulin based on pre-programmed basal profiles to diabetic patients, as well as to determine and/or administer one or more suitable bolus levels (e.g., carbohydrate bolus, and correction bolus).

In a further aspect, the receiver unit 104 and the data processing terminal/delivery unit 105 may be integrated into a single housing with a shared user input/output modules or units such that the user is conveniently provided with less devices in the overall system to handle and carry or wear. In such cases, the integrated receiver unit 104 and data processing terminal/delivery unit 105 may be configured to directly communicate with the transmitter unit 102 to receive and/or transmit data, signal and/or instructions or requests for information.

Referring again to FIG. 1, the receiver unit 104 may include a personal computer, a portable computer such as a laptop or a handheld device (e.g., personal digital assistants (PDAs)), mobile telephones such as cellular telephones, Blackberry® devices, Palm Treo® devices, Apple iPhone devices, and the like, each of which may be configured for data communication with the receiver via a wired or a wireless connection. Additionally, the receiver unit 104 may further be connected to a data network (not shown) for storing, retrieving and updating data corresponding to the monitored analyte levels of the patient.

In this manner, in a further aspect, the receiver unit 104 functionalities may be integrated into an existing consumer products so that the user or the patient can enable or use the analyte monitoring system and/or medication delivery unit while minimizing the number of additional devices to carry around or wear in the user's clothing, on the belt with a belt clip, for example.

Furthermore, in one embodiment of the present disclosure, the receiver unit 104 or the data processing terminal 105, or both the receiver unit 104 and the data processing terminal 105 may be configured to incorporate a blood glucose meter so as to be configured to include, for example, a test strip port for receiving a glucose test strip. In this embodiment of the present disclosure, the receiver unit 104 and the data processing terminal 105 may be configured to perform analysis upon the sample from the glucose test strip so as to determine the glucose level from the test strip. One example of such strip meter is Freestyle® glucose meter commercially available from the assignee of the present disclosure, Abbott Diabetes Care, Inc. of Alameda Calif. The blood glucose meter may be used to calibrate the analyte sensor 101 periodically and/or as may be needed

In a further aspect, a lancing device may be provided and operatively coupled to the receiver unit 104. For example, in one aspect, the receiver unit 104 housing may be configured to integrate a lancing device for use in conjunction with the blood glucose test strip.

Furthermore, as discussed above, within the scope of the present disclosure, the data processing terminal 105 may include an infusion device such as an insulin infusion pump or the like, which may be configured to administer insulin to patients, and which may be configured to communicate with the receiver unit 104 for receiving, among others, the measured glucose level. Alternatively, the receiver unit 104 may be configured to integrate an infusion device therein so that the receiver unit 104 is configured to administer insulin therapy to patients, for example, for administering and modifying basal profiles, as well as for determining appropriate boluses for administration based on, among others, the detected analyte levels received from the transmitter unit 102.

Additionally, the transmitter unit 102, the receiver unit 104 and the data processing terminal 105 may each be configured for bi-directional wireless communication such that each of the transmitter unit 102, the receiver unit 104 and the data processing terminal 105 may be configured to communicate (that is, transmit data to and receive data from) with each other via the wireless communication link 103. More specifically, the data processing terminal 105 may in one embodiment be configured to receive data directly from the transmitter unit 102 via the communication link 106, where the communication link 106, as described above, may be configured for bi-directional communication. In this embodiment, the data processing terminal 105 which may include an insulin pump, may be configured to receive the analyte signals from the transmitter unit 102, and thus, incorporate the functions of the receiver 103 including data processing for managing the patient's insulin therapy and analyte monitoring.

Each of the devices in the overall system 100 in FIG. 1 including, for example, the transmitter unit 102, the receiver unit 103, and the data processing terminal/delivery unit 105 may be configured for communication such that, in the overall system, each of these components may be configured to transmit one or more signals to another one or more of these components to request information therefrom, transmit signals acknowledging receipt or information in response to such requests, maintain signal communication over a predetermined time periods, periodically “ping” each other to confirm or verify the communication connection, pass encryption/decryption keys and/or device or component identification codes or unique identifier information to maintain secure data exchange between the components, and the like.

In one embodiment, the communication link 103 may include one or more of an RF communication protocol, an infrared communication protocol, a Bluetooth enabled communication protocol, an 802.11x wireless communication protocol, or an equivalent wireless communication protocol which would allow secure, wireless communication of several units (for example, per HIPPA requirements) while avoiding potential data collision and interference. In another embodiment, the communication link 103 may include wired connection including USB connection, mini USB connection, or any other suitable wired or cabled connection.

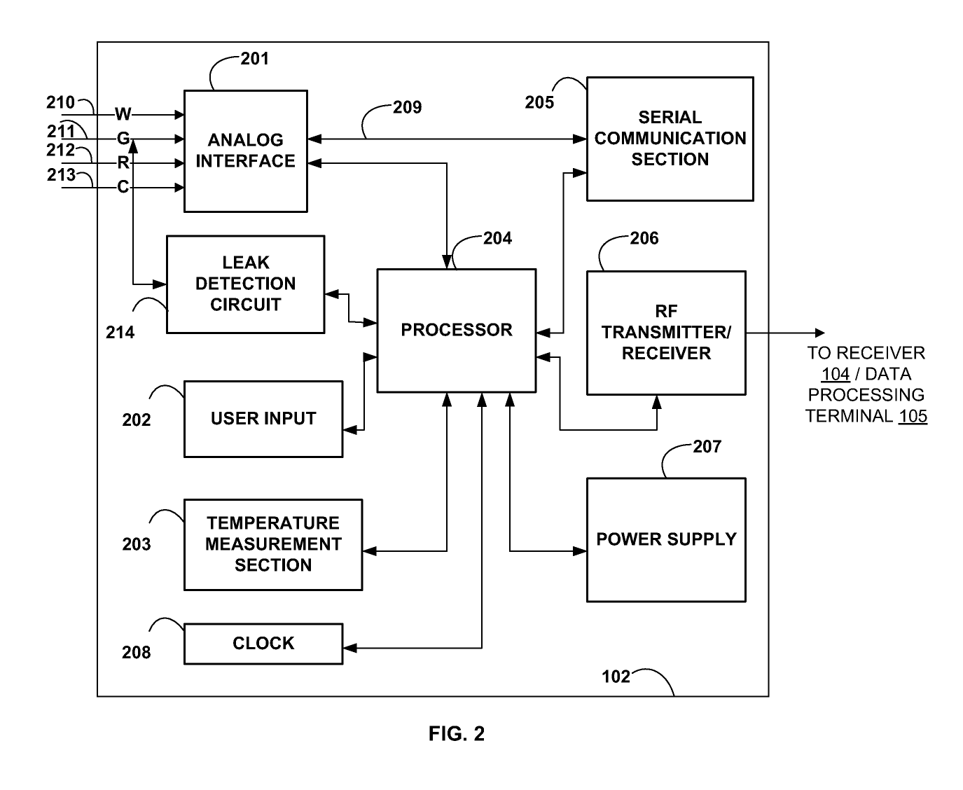

FIG. 2 is a block diagram of the transmitter of the data monitoring and detection system shown in FIG. 1 in accordance with one embodiment of the present disclosure. Referring to the Figure, the transmitter 102 in one embodiment includes an analog interface 201 configured to communicate with the sensor 101 (FIG. 1), a user input 202, and a temperature detection section 203, each of which is operatively coupled to a transmitter processor 204 such as a central processing unit (CPU). As can be seen from FIG. 2, there are provided four contacts, three of which are electrodes—work electrode (W) 210, guard contact (G) 211, reference electrode (R) 212, and counter electrode (C) 213, each operatively coupled to the analog interface 201 of the transmitter 102 for connection to the sensor unit 201 (FIG. 1). In one embodiment, each of the work electrode (W) 210, guard contact (G) 211, reference electrode (R) 212, and counter electrode (C) 213 may be made using a conductive material that is either printed or etched, for example, such as carbon which may be printed, or metal foil (e.g., gold) which may be etched.

Further shown in FIG. 2 are a transmitter serial communication section 205 and an RF transmitter 206, each of which is also operatively coupled to the transmitter processor 204. Moreover, a power supply 207 such as a battery is also provided in the transmitter 102 to provide the necessary power for the transmitter 102. Additionally, as can be seen from the Figure, clock 208 is provided to, among others, supply real time information to the transmitter processor 204.

In one embodiment, a unidirectional input path is established from the sensor 101 (FIG. 1) and/or manufacturing and testing equipment to the analog interface 201 of the transmitter 102, while a unidirectional output is established from the output of the RF transmitter 206 of the transmitter 102 for transmission to the receiver 104. In this manner, a data path is shown in FIG. 2 between the aforementioned unidirectional input and output via a dedicated link 209 from the analog interface 201 to serial communication section 205, thereafter to the processor 204, and then to the RF transmitter 206. As such, in one embodiment, via the data path described above, the transmitter 102 is configured to transmit to the receiver 104 (FIG. 1), via the communication link 103 (FIG. 1), processed and encoded data signals received from the sensor 101 (FIG. 1). Additionally, the unidirectional communication data path between the analog interface 201 and the RF transmitter 206 discussed above allows for the configuration of the transmitter 102 for operation upon completion of the manufacturing process as well as for direct communication for diagnostic and testing purposes.

As discussed above, the transmitter processor 204 is configured to transmit control signals to the various sections of the transmitter 102 during the operation of the transmitter 102. In one embodiment, the transmitter processor 204 also includes a memory (not shown) for storing data such as the identification information for the transmitter 102, as well as the data signals received from the sensor 101. The stored information may be retrieved and processed for transmission to the receiver 104 under the control of the transmitter processor 204. Furthermore, the power supply 207 may include a commercially available battery.

The transmitter 102 is also configured such that the power supply section 207 is capable of providing power to the transmitter for a minimum of about three months of continuous operation after having been stored for about eighteen months in a low-power (non-operating) mode. In one embodiment, this may be achieved by the transmitter processor 204 operating in low power modes in the non-operating state, for example, drawing no more than approximately 1 μA of current. Indeed, in one embodiment, the final step during the manufacturing process of the transmitter 102 may place the transmitter 102 in the lower power, non-operating state (i.e., post-manufacture sleep mode). In this manner, the shelf life of the transmitter 102 may be significantly improved. Moreover, as shown in FIG. 2, while the power supply unit 207 is shown as coupled to the processor 204, and as such, the processor 204 is configured to provide control of the power supply unit 207, it should be noted that within the scope of the present disclosure, the power supply unit 207 is configured to provide the necessary power to each of the components of the transmitter unit 102 shown in FIG. 2.

Referring back to FIG. 2, the power supply section 207 of the transmitter 102 in one embodiment may include a rechargeable battery unit that may be recharged by a separate power supply recharging unit so that the transmitter 102 may be powered for a longer period of usage time. Moreover, in one embodiment, the transmitter 102 may be configured without a battery in the power supply section 207, in which case the transmitter 102 may be configured to receive power from an external power supply source (for example, a battery) as discussed in further detail below.

Referring yet again to FIG. 2, the temperature detection section 203 of the transmitter 102 is configured to monitor the temperature of the skin near the sensor insertion site. The temperature reading is used to adjust the analyte readings obtained from the analog interface 201. The RF transmitter 206 of the transmitter 102 may be configured for operation in the frequency band of 315 MHz to 322 MHz, for example, in the United States. Further, in one embodiment, the RF transmitter 206 is configured to modulate the carrier frequency by performing Frequency Shift Keying and Manchester encoding. In one embodiment, the data transmission rate is 19,200 symbols per second, with a minimum transmission range for communication with the receiver 104.

Referring yet again to FIG. 2, also shown is a leak detection circuit 214 coupled to the guard electrode (G) 211 and the processor 204 in the transmitter 102 of the data monitoring and management system 100. The leak detection circuit 214 in accordance with one embodiment of the present disclosure may be configured to detect leakage current in the sensor 101 to determine whether the measured sensor data are corrupt or whether the measured data from the sensor 101 is accurate.

Additional detailed description of the continuous analyte monitoring system, its various components including the functional descriptions of the transmitter are provided in U.S. Pat. No. 6,175,752 issued Jan. 16, 2001 entitled “Analyte Monitoring Device and Methods of Use”, and in application Ser. No. 10/745,878 filed Dec. 26, 2003 entitled “Continuous Glucose Monitoring System and Methods of Use”, each assigned to the Assignee of the present application, and the disclosures of each of which are incorporated herein by reference for all purposes.

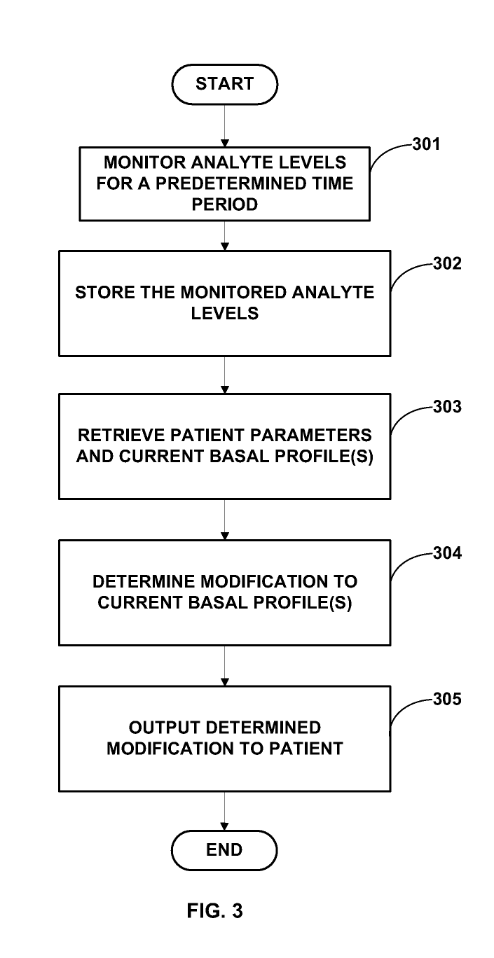

FIG. 3 is a flowchart illustrating the process for monitoring analyte levels and determining modification to a current basal profile in accordance with one embodiment of the present disclosure. Referring to FIG. 1, at step 301, the analyte levels such as the patient's analyte level is monitored for a predetermined period of time, and at step 302, the monitored analyte levels is stored in a data storage unit (for example, in one or more memory devices of the receiver unit 104 and/or the data processing terminal 105). Thereafter, at step 303, patient specific parameters are retrieved from the data processing terminal 105 and/or the receiver unit 104, as well as the current basal profile(s) which the patient is implementing to operate the infusion device for insulin delivery during the time period of the analyte monitoring discussed above.

In one embodiment, patient specific parameters may include the type of insulin currently being infused into the patient, the patient's insulin sensitivity, insulin resistance level, level of insulin on board, the specific time period of the analyte monitoring, including the activities performed by the patient during that time period, or any other factors and variables that may have an impact upon the effectiveness of insulin therapy for the patient.

Referring to FIG. 3, after retrieving the patient specific parameters and the current basal profile(s) that the patient is implementing in the infusion device at step 303, at step 304, the monitored analyte levels are retrieved and, based on one or more patterns from the analyte levels monitored and factoring in the current basal profile(s), a recommendation or modification to the current basal profile(s) is determined. Thereafter, the recommendation or modification to the current basal profiles(s) determined at step 304 is provided to the patient visually on a display or audibly, or a combination of visual and audio output, such that the patient may be able to decide whether the modification to the current basal profile(s) is appropriate or suitable to the patient.

While the modification to the basal profile(s) is discussed above as output to the patient, within the scope of the present disclosure, the basal profile modification determined in accordance with one embodiment of the present disclosure may be provided to a health care provider so as to determine suitability of the modification to the current basal profile in view of the monitored analyte levels. Furthermore, in an alternate embodiment, the determined modification to the current basal profile may be provided to both the patient and the health care provider so that the patient is able to make an informed decision as to whether the recommended modification to the current basal profile is suitable for the patient in improving insulin therapy to better manage diabetes.

Within the scope of the present disclosure, the modification to the current basal profile may include several factors that are considered including, for example, the current basal profile as a function of the time period during which insulin infusion takes place and analyte levels are monitored, the level of the analyte monitored as a function of time, patient specific parameters discussed above including, for example, patient's activities during the monitored time period, patient's diet, insulin sensitivity, level of insulin on board, and the insulin type, and the frequency of bolus dosing during the time period of the analyte level monitoring (for example, the number of correction bolus dosing, and/or carbohydrate dosing).

In this manner, in one embodiment of the present disclosure, the modification to the current basal profile(s) may be achieved for one or more specific goals for the patient's diabetes management, including for example, elimination of extreme glucose excursions, automating or semi-automating routine or regular bolus dosing, and adjustment to the mean glucose value.

For example, to effectively eliminate extreme glucose excursions, the modification to the current basal profiles may be configured to provide recommendation to modify to reduce extreme levels, so that unless the monitored glucose level exceeds a predetermined threshold level (e.g, 200 mg/dL), modification to the current basal profile is not recommended. In the case of automating regular bolus dosing, based on the monitored analyte levels, a regular correction bolus dosing during the current basal profile implantation may be converted into a modification to the current basal profile so that the patient may effectively rid of the need to implement routine correction type bolus dosing. Additionally, with the collected data from the continuously monitored analyte levels, the current basal profile may be modified to adjust the mean target glucose value even in the case where extreme excursions of glucose levels do not occur.

Within the scope of the present disclosure, the current basal profile modification may be performed at different times during the time that the patient is using an infusion device. For example, the patient may perform the current basal profile modification procedure discussed above on a daily basis if, for example, glucose excursions are anticipated on a regular basis. Alternatively, the current basal profile modification procedure may be performed each time a bolus is administered.

Moreover, within the scope of the present disclosure, when a pattern of glucose excursions is detected over several days (for example, 48 or 72 hours), the analyte monitoring and management system 100 (FIG. 1) may be configured to continue analyte level monitoring to determine whether a pattern exists in the frequency and/or level of the glucose excursions. In such a case, it is possible to modify the current basal profile modification procedure to correct for such patterns in the monitored analyte levels such that the modification to the current basal profile may address such excursions

In a further embodiment, the loop gain setting may be configured to determine the appropriate level of modification to the current basal profiles for a given glucose excursion pattern detected based on the monitored analyte levels. While several iterations may be necessary for low loop gain to reach the optimal modification level of the current basal profile, a conservative and less aggressive modification may be recommended in such cases. For medium loop gain, when critically controlled, the determined recommendation for modification to the current basal profile may be reached based on one iteration, but with the potential for an increased risk for overshoot and thereby resulting in over-compensation. Notwithstanding, the loop gain setting may be trained into the analyte monitoring and management system 100 so that by starting with a low loop gain and then learning the loop responses to reach the optimal loop gain, the desired modification to the current basal profile may be determined and provided to the patient.

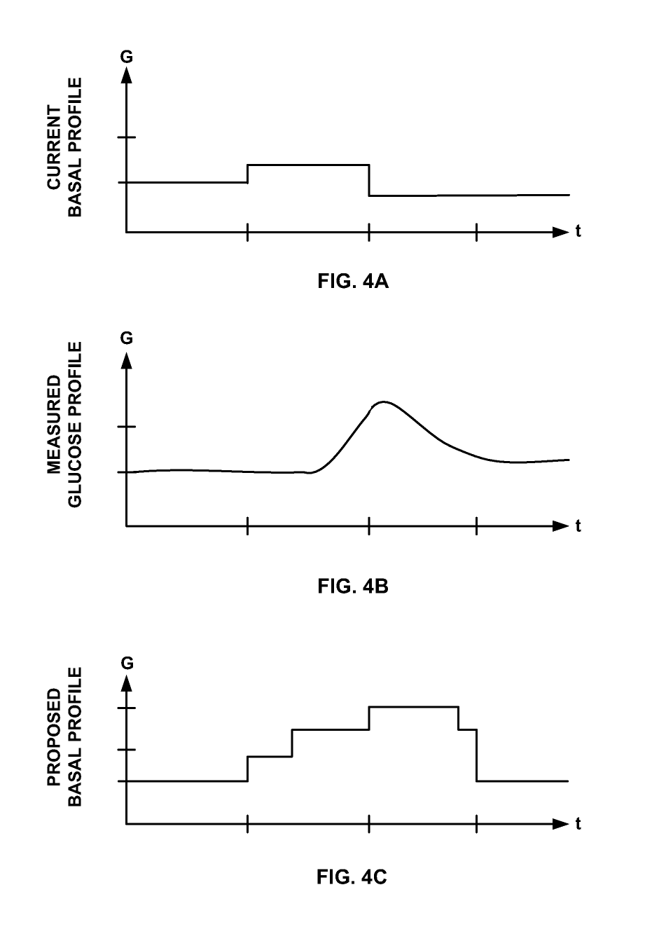

FIGS. 4A-4C illustrate a current basal profile, a monitored analyte level profile, and a modified basal profile recommendation respectively, in accordance with one embodiment of the present disclosure. Referring to FIG. 4A, a profile of the glucose level as a function of time is shown for a current basal profile programmed into the infusion device of the patient. FIG. 4B illustrates a profile of the glucose levels as a function of time for the same time period during which the basal profile shown in FIG. 4A is administered to the patient. Finally, FIG. 4C illustrates a profile of glucose level as a function of time which factors in the patient parameters including the monitored glucose levels of the patient, to provide a modification to the current basal profile so as to improve the patient's insulin therapy.

Indeed, in one embodiment of the present disclosure, it can be seen that the analyte level monitoring and detecting patterns in the monitored analyte levels during the time period that the patient is using an infusion device such as an insulin pump running a pro-programmed basal profile, provides contemporaneous patient response of the infused insulin based on the current basal profile, and thus, it is possible to improve the insulin therapy.

By way of an example, in the case that the patient desired to eliminate or substantially reduce the occurrences of high glucose extremes or excursions, it is determined whether there is a consistent pattern of high glucose levels versus time of day of such occurrence based on the monitored glucose levels. An example of such monitored levels is shown in the Table 1 below:

TABLE 1
High Glucose Excursions

| | 00:00 | 00:30 | 01:00 | 01:30 | 23:30 |
|---|---|---|---|---|---|
| Day 1 (0-24 hr) | | | 1 | 1 | |
| Day 2 (24-48 hr) | 1 | | 1 | 1 | |
| Day 3 (48-72 hr) | 1 | 1 | 1 | | |
| Sum | 2 | 1 | 3 | 2 | 0 |

where over a 72 hour period post calibration of the sensor 101 (FIG. 1), the monitored data is reviewed to determine if the monitored glucose level exceeds a predetermined threshold level. Each occurrence of when the glucose level exceeds a predetermined threshold level is shown with a “1” in Table 1 above.

For each column shown in Table 1 where the sum of the data entry equals “3”, and the sum of the adjacent columns is equal to or greater than “1”, the analyte monitoring and management system 100 in one embodiment may be configured to recommend an increase to the current basal profile for that time slot or period during the 72 hour period.

More specifically, using a conventional bolus calculation mechanism, a correction bolus may be determined based on the detection of the high glucose level. Thereafter, rather than implementing the calculated correction bolus, the modification to the current basal profile may be determined based on the following relationship:

Modification=K*Calculated Correction Bolus/30 minutes (1)

where K is a loop gain value determined by the patient's health care provider, and is typically less than 1 for over dampened control, and further, where the 30 minutes is a scaling factor for the Modification determination.

After the calculation, the determined Modification from the equation (1) above is provided to the patient to either accept and implement, storage for further analysis or modification, or reject.

In one embodiment, the Modification determination based on relationship described in the equation (1) above may include glucose rate or higher derivative information, or alternatively, may also include an integral factor. In a further embodiment, the determination may also factor in the glucose profile variation. Other potentially relevant factors also include the physiological dynamics and/or sensor/monitor dynamics, as well as the patient's insulin infusions, caloric intake, exercise, etc.

As another example, in the case where correction bolus dosing may be replaced with modification to the current basal profiles based on the monitored analyte levels, a consistent pattern in the monitored analyte levels of bolus delivery versus time of day is determined. Table 2 below shows one example of such pattern:

TABLE 2
Bolus Replacement

| | 00:00 | 00:30 | 01:00 | 01:30 | 23:30 |
|---|---|---|---|---|---|
| Day 1 (0-24 hr) | | | 1 | 1 | |
| Day 2 (24-48 hr) | 1 | | 1 | 1 | |
| Day 3 (48-72 hr) | 1 | 1 | 1 | | |
| Sum | 2 | 1 | 3 | 2 | 0 |

Referring to Table 2 and in conjunction with equation (1) discussed above, the administration of bolus doses is reviewed and if, for example, there were three bolus deliveries (each shown in Table 2 with a “1” entry) within 30 minutes of the same time of day period, then an increase in the insulin level for same time period may be proposed to the current basal profile using equation (1) to determine the level of modification to the current basal profile.

In the case of addressing the occurrence of low extremes of glucose levels, similar determinations as above may be performed given the monitored analyte levels for the desired time period and data reviewed for detection of patterns in the monitored analyte levels associated with the occurrences of low extremes. For example, Table 3 below provides data for a three day period illustrating patterns associated with the occurrences of low extremes.

TABLE 3
Low Extremes Pattern

| | 00:00 | 00:30 | 01:00 | 01:30 | 23:30 |
|---|---|---|---|---|---|
| Day 1 (0-24 hr) | | | 1 | 1 | |
| Day 2 (24-48 hr) | 1 | | 1 | 1 | |
| Day 3 (48-72 hr) | 1 | 1 | 1 | | |
| Sum | 2 | 1 | 3 | 2 | 0 |

where the “1” entry in a particular column illustrates the occurrence of the measured glucose level that is below a predetermined low threshold level.

Again, in conjunction with equation (1) above, a modification to the current basal profile may be determined and provided to the patient. More specifically, where over a 72 hour period post calibration of the sensor 101 (FIG. 1), the monitored data is reviewed to determine if the monitored glucose level falls below the predetermined low threshold level, each such is shown with a “1” in Table 3 above.

For each column shown in Table 3 where the sum of the data entry equals “3”, and the sum of the adjacent columns is equal to or greater than “1”, the analyte monitoring and management system 100 in one embodiment may be configured to recommend a modification to the current basal profile for that time slot or period during the 72 hour period based on the relationship set forth in equation (1). The user or patient may then be provided with the modification to the current basal profile which may be accepted for implementation, stored for further analysis or modification, or rejected by the patient.

In the case of reducing the mean glucose level using the analyte monitoring and management system 100 in one embodiment of the present disclosure, again, consistent patterns in the monitored analyte levels over a predetermined time period is analyzed and detected as a function of time of day of the analyte level monitoring. Table 4 below shows an example of such pattern:

TABLE 4
Mean Glucose Level

| | 00:00 | 00:30 | 01:00 | 01:30 | 23:30 |
|---|---|---|---|---|---|
| Day 1 (0-24 hr) | | | 1 | 1 | |
| Day 2 (24-48 hr) | 1 | | 1 | 1 | |
| Day 3 (48-72 hr) | 1 | 1 | 1 | | |
| Sum | 2 | 1 | 3 | 2 | 0 |

where, an entry of a “1” in Table 4 above illustrates a detected glucose level of greater than a predetermined level (e.g., 120) during the three day period based on the data from the sensor 101 (FIG. 1).

Again, similar to the determinations above, if the sum of any column in Table 4 is equal to three, and the sum of the adjacent columns is greater than or equal to one, then a decrease in the current basal profile for that particular time slot is recommended based on the relationship set forth above in equation (1).

In a further embodiment, a 24 hour profile may be determined based on time-of-day averages over a predetermined number of days. The correction factor may then be based on maintaining the time-of-day averages within a predetermined target range value. Within the scope of the present disclosure, the various approaches and implementations for correction calculation and/or basal profile modification recommendation may be combined or implemented individually, depending upon the patient's physiology and the criteria for drug therapy such as insulin therapy.

In accordance with the various embodiments of the present disclosure, additional or alternative approaches to the determination of the modification to the basal profile may include, for example, (1) modifying the basal rate by a constant value, (2) changing the basal rate by a constant percentage of the current basal profile rate, (3) changing the basal rate in proportion to the magnitude of the error, or (4) changing the basal rate in proportion to the magnitude of the error, compensating for the loop gain factor based on the affects of the previous basal rate modifications/adjustments. Each of these approaches within the scope of the present disclosure is described in further detail below.

In the first embodiment described above, the basal rate is configured for modification by a constant amount. For example, the modification is described by the following equation (2):

Modification=sign(measured−target)*U (2)

where U is a constant value in insulin units, and is applied to the difference between the target glucose and measured glucose levels.

Moreover, the “sign(measured−target)” relationship holds the following:
if (measured−target)=0, then 0
else if (measured−target)>0, then +1
else if (measured−target)<0, then −1

For example, in the equation (2) above, the constant value U may be 0.1 units of insulin/hour. This may be a configurable value. Indeed, for the case where U is 0.1 units, if the measured glucose level is 140, while the target glucose level is 100, then the Modification to the basal rate would result in +1*0.1 equaling 0.1 units/hour.

In this manner, in one embodiment, a simple and effective basal rate modification approach is provided and which does not require knowledge of the patient's physiology, is simple to implement, and does not provide resolution issues. On the other hand, for safely values of the contact factor U, several iterations or corrections may be needed to reach the desired results.

In another embodiment, the basal rate may be modified by a constant percentage of the current rate. In this case, the following equation (3) holds:

Modification=sign(measured−target)*K*U (3)

where K=constant percentage, 0<=K<=1, and U=current basal rate(in units of insulin).

For example, where the constant percentage K is 0.1 and with the current basal rate U of 2.0 units/hour, and for example, the measured and target glucose levels at 140 and 100, respectively, the basal rate Modification in accordance with the equation (3) equals +1*0.1*2.0=0.2 units/hour. In this manner, in one embodiment, a simple and effective way to implement basal rate modification is provided, and which does not require the knowledge of the user's physiology. For safe values of the constant percentage K, several iterations may be needed to reach the desired level of basal rate modification, and resolution issues may potentially arise.

In a further embodiment of the present disclosure, the modification to the basal rate may be determined by changing the basal rate proportional to the magnitude of the error. In this case, the following equation (4) holds:

Modification=(measured−target)*K*P (4)

where K is the loop gain factor, and for example, K<1 for dampened control, K=1 for critical control, K>1 for over control, and further, where P is the patient's physiological response to insulin (insulin sensitivity).

For example, in the case where the loop gain factor K is 0.75, the patient's insulin sensitivity P is 0.02 units/mg/dL, and where the measured and target glucose levels are 140 and 100, respectively, the Modification to the basal rate in accordance to equation (4) is determined to be (140-100)*0.75*0.02=0.6 units/hour. This approach requires prior determination of the patient's insulin sensitivity, and may likely require less iterations or corrective routines to reach the desired level of basal rate modification for effective treatment.

In still a further embodiment, the modification to the basal rate may be determined by the changing the basal rate proportional to the magnitude of error, and further making adjustment to the loop gain factor based on the results of the prior basal rate adjustments. For example, the following equation (5) holds:

with K=f(affect of last adjustment)

Modification=(measured−target)*K*P (5)

where K is loop gain factor, and P is the patient's physiology response to insulin (insulin sensitivity).

For example, if the loop gain factor is initially 0.75, then the determined basal rate modification is the same as in the embodiment described above in conjunction with equation (4). In the next iteration, with the measured glucose level still higher than the target level, the look gain factor is increased. In this case, for example, with measured glucose level of 110 where the target level is 100, the new loop gain factor K is determined to be ((first delta)/(first change))*old K=(40/30)*0.75=1.00.

Having determined the new loop gain factor K, the basal rate modification is determined by equation (5) as (110−100)*1.00*0.02=0.2 units/hour. It is to be noted that if the loop gain factor K did not change between the two iterations described above, then the basal rate modification in the second iteration may be relatively smaller, and it can be seen that the adjustment to the loop gain factor allows faster settling to the final value. For example, using equation (5) above, the basal rate modification is determined as:

Modification=(110−100)*0.75*0.02=0.15 units/hour

In this manner, in one embodiment of the present disclosure, the basal rate modification may be configured to self adjust to the patient's physiology such that it may be more tolerant of inaccurate input values.

In this manner, the various embodiments of the present disclosure provides a mechanism for diabetic patients to compare the actual glucose levels during a predetermined time period and to use that information in addition to the actual basal profile to recommend a new or modified basal profile to the patient. The patient will have the option to accept the recommendation, the accept the recommendation with the modification, or alternatively to decline the proposed modified basal profile so as to select the most appropriate basal profile for the patient.

Moreover, contrasting with real time closed loop insulin therapy where the insulin infusion is modified at a rate (i.e., minutes) much faster than the physiological response times, one embodiment of the present disclosure is characterized by a) corrections to basal profiles that are made over periods (i.e., days) which are much longer than physiological response times, and b) corrections based on repeating diurnal glucose patterns. In this manner, in one embodiment, the present disclosure is configured to identify the patient's glucose levels retrospectively over a predetermined period of time (for example, over a 24 hour period) to determine any recommended modification to the existing basal profiles. In this manner, the recommended modification to the basal profiles will be a function of the actual measured glucose values of the patient under the existing basal profiles.

In the manner described above, in accordance with the various embodiments of the present disclosure, the patient and the doctor or educator may work together to adjust the insulin profile to the patient's activities. This may require experience and some trial and error as well. An automated basal profile correction in accordance with the embodiments of the present disclosure may monitor and gather much more information and may incorporate the knowledge of the physician/educator within the modification algorithm. Indeed, different objectives can be identified and the modification algorithms developed to achieve the objectives.

Accordingly, a method in one embodiment includes monitoring an analyte level of a patient, retrieving a predetermined parameter, and determining a modification to an drug therapy profile based on the monitored analyte level and the predetermined parameter.

The analyte includes glucose, and the drug infusion rate may include a basal profile.

Further, the predetermined parameter may include one or more of an insulin sensitivity, a drug infusion rate, and a drug infusion time period, a time period corresponding to the monitored analyte level, a time of day associated with the monitored analyte level, or a loop gain factor.

Moreover, the monitoring step may include determining the analyte level of the patient at a predetermined time interval including one of 5 minutes, 30 minutes, 1 hour, or 2 hours.

The method in one embodiment may further including the step of outputting the modification to the drug therapy profile to the patient.

Also, the method may additionally include the step of implementing the modification to the drug therapy profile.

In a further aspect, the drug therapy profile may include an insulin infusion profile.

A system in yet another embodiment of the present disclosure includes an analyte monitoring unit, and a processing unit operatively coupled to the analyte monitoring unit, the processing unit configured to receive a plurality of monitored analyte levels of a patient, and to determine a modification to a drug therapy profile based on the received plurality of monitored analyte levels.

The analyte monitoring unit in one embodiment may include a sensor unit provided in fluid contact with an analyte of a patient.

Further, the sensor unit may include a subcutaneous analyte sensor, a transcutaneous analyte sensor, and a transdermal patch sensor.

Moreover, the processing unit may be operatively coupled to an infusion device. In a further aspect, the infusion device may be integrated with the processing unit and the analyte monitoring unit in a single housing such that the processing unit is configured at least in part to control the operation of the analyte monitoring unit and the infusion device.

In a further aspect, the processing unit may include an insulin pump, including for example, external infusion pump, a compact, on-body patch pump, or an implantable infusion pump.

Moreover, in still another aspect, the processing unit may be is configured to determine the modification based on a pattern in the monitored analyte level, where the pattern may be determined based on the plurality of monitored analyte levels for a predetermined time period, and further, where the predetermined time period may include one of a 12 hour period, or 24 hour period.

The system in yet another embodiment may include a display unit operatively coupled to the processing unit for displaying the determined modification.

In one aspect, the system may include a blood glucose meter operatively coupled to one or more of the analyte monitoring unit or the processing unit or both, including, for example, a strip port provided on its housing to receive a blood glucose test strip. In a further aspect, the blood glucose meter including the test strip port may be integrated with the one or more of the analyte monitoring unit or the processing unit or both in one or more compact housings.

In a further aspect of the present disclosure, the medication dosage level using, for example, the receiver unit 104 (FIG. 1) and/or the delivery unit 105 (FIG. 1) may be configured as one or more query functions to retrieve, based on a prior set of stored values, the appropriate or desired medication dosage amount based on one or more input parameters such as the amount of carbohydrate intake, or blood glucose levels. That is, the microprocessor or the processing device in the receiver unit 104 and/or the deliver unit 105 may be configured to perform a simple query or search function to retrieve data from one or more storage units such as memory devices, rather than executing or performing extensive calculation based on input parameters to determine the medication level.

That is, in one aspect of the present disclosure, a simple bolus look up procedure is provided as a component of an insulin pump, an analyte monitoring device or a blood glucose meter, or one or more combinations thereof, such that the processing unit of such devices or combined devices is not burdened with the execution task of bolus calculation algorithm. Rather, the processing unit is configured to perform a simple search function to determine the suitable bolus dosage amount.

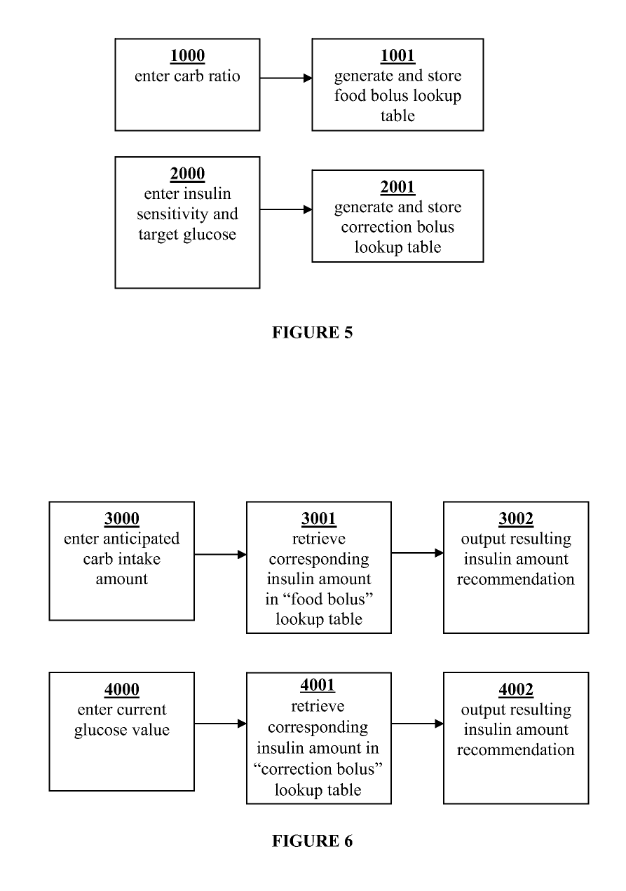

More specifically, in one aspect, the determination of a desired medication level such as a carbohydrate bolus and/or correction bolus amount may be performed based on generated and/or stored lookup tables retrieved from a storage unit such as a memory device. Indeed, in one aspect, when the user first sets up the infusion device such as an insulin pump, the patient defines the carbohydrate ratio, insulin sensitivity and target blood glucose parameters, among others. These parameters can also be adjusted later. As shown in FIG. 5, in one aspect, the user can set/adjust these settings (1000, 2000) via the user interface of the pump. Alternatively, the parameters may be set/adjusted on the user interface of a remote controller in wireless communication with the pump, and/or the user interface of an external personal computer, or a networked server, and/or via some other suitable device in communication with the pump such as, for example, a mobile telephone enabled for such communication.

In one embodiment, the look up tables can be generated (1001, 2001) by the pump processor once the parameters have been set or adjusted. Alternatively, the look up table generation can be performed on the remote controller, and/or an external PC, or via some other device such as a cellular telephone. For instance, a PC may be used to input the parameters, the parameters could be downloaded into the remote device, and the remote device could generate the tables. The lookup tables may be stored on the pump, and/or stored on the remote controller.

In addition, the look up tables may be continuously updated and revised based on recent or current data such as, for example, recently administered correction or carbohydrate bolus dosage. Additionally, the resolution of the look up table may be increased such that additional parameters such as time of day information, location information and the like may be associated with the respective corresponding medication dosage level and stored in the memory device.

### Generation of Look-Up Tables

When a “carb ratio” is set/adjusted, the pump processor determines an “insulin amount” for each possible “carb input amount”, for example, based on the following:

Insulin amount=carb input amount/carb ratio.

Each of determined “insulin amounts” are entered into the food bolus table associated with the corresponding “carb input amount”.

For example, if the “carb input amount” can range from 1 to 500 grams with increments of 1 gram, then 500 table entries are needed. For a “carb ratio” of 12 grams/Unit, a portion of the lookup table may be represented as follows:

| Carbs | Food Bolus |
|---|---|
| 15 grams | 1.25 U |
| 16 grams | 1.33 U |
| 17 grams | 1.42 U |
| 18 grams | 1.50 U |
| 19 grams | 1.58 U |
| 20 grams | 1.67 U |

When an “insulin sensitivity” and/or “target glucose” is set/adjusted, the pump processor determines an “insulin amount” for each possible “current glucose” for example, based on the following:

Insulin amount=(Current glucose−target glucose)/insulin sensitivity.

Each of these “insulin amounts” are entered into the correction bolus table associated with the corresponding “current glucose”.

If the “current glucose” can range from 20 to 500 mg/dL with increments of 1 mg/dL, then 481 table entries in the look up table are required. For an “insulin sensitivity” of 45.6 mg/dL per Unit, a portion of this example table would look as follows:

| Current Glucose | Correction Bolus |
|---|---|
| 173 mg/dL | 1.60 U |
| 174 mg/dL | 1.62 U |
| 175 mg/dL | 1.64 U |
| 176 mg/dL | 1.67 U |
| 177 mg/dL | 1.69 U |
| 178 mg/dL | 1.71 U |

In another aspect, a single 2-input table may be implemented with “carb input amount” and “current glucose” as inputs. A “total insulin” recommendation would be associated with each input pair. The food “insulin amount” and correction “insulin amount” could also be included in this table. The look up table would include 240,500 entries. A portion of this table is shown below:

| Current Glucose | Carbs | Total Bolus |
|---|---|---|
| 175 | 498 | 43.1447368 |
| 175 | 499 | 43.2280702 |
| 175 | 500 | 43.3114035 |
| 176 | 1 | 1.75 |
| 176 | 2 | 1.83333333 |
| 176 | 3 | 1.91666667 |
| 176 | 4 | 2 |
| 176 | 5 | 2.08333333 |
| 176 | 6 | 2.16666667 |
| 176 | 7 | 2.25 |
| 176 | 8 | 2.33333333 |
| 176 | 9 | 2.41666667 |
| 176 | 10 | 2.5 |
| 176 | 11 | 2.58333333 |
| 176 | 12 | 2.66666667 |
| 176 | 13 | 2.75 |
| 176 | 14 | 2.83333333 |
| 176 | 15 | 2.91666667 |
| 176 | 16 | 3 |
| 176 | 17 | 3.08333333 |
| 176 | 18 | 3.16666667 |
| 176 | 19 | 3.25 |
| 176 | 20 | 3.33333333 |

The size of the table could be reduced if the range and/or resolution of the inputs was reduced. For instance, if the “carb input amount” was rounded to the nearest 5 grams, and the “current glucose” was rounded to the nearest 5 mg/dL, then the number of entries in this integrated table would be reduced to 9700.

In one aspect, each of the generated lookup table may be stored in one or more memory devices in the data processing terminal/infusion device 105, the receiver unit 104, or at a remote location for access via a networked connection, for example. In a further aspect, a discrete blood glucose meter may include one or more memory devices to store the generated lookup table, and where the microprocessor or processing unit of the blood glucose meter is configured to perform the query function to retrieve the appropriate bolus amount based on the parameters such as the glucose levels and/or the carbohydrate amount.

As discussed above, within the scope of the present disclosure, the lookup table may include other parameters such as time of day information, patient physiological condition, present and/or past glycemic level, variation range in the glucose ranges for defined time periods, modified insulin sensitivity, type of insulin used, frequency of out of range glycemic level (for example, hyperglycemic or hypoglycemic condition), and the like. One or more of these parameters may be associated with the stored medication dosage level in the lookup table, such that the memory unit is configured to store the various parameters and association of these parameters in a multi-dimensional database array.

Within the scope of the present disclosure, other configuration of the database or lookup table stored in one or more of the memory unit of the blood glucose meter, receiver unit of the analyte monitoring system, and/or the infusion device are contemplated. Additionally, the lookup table or database may be updated or modified on an on-going basis based on, for example, subsequent administration or bolus dosage.

In addition, while correction and carbohydrate bolus dosage lookup table generation is discussed, within the scope of the present disclosure, other variations of the medication dosage level may be stored in the lookup table or database such as, for example, an extended bolus (or dual bolus), a profiled bolus (such as a square wave bolus or a ramp bolus, for example), a temporary basal amount, or any other medication dosage amount.

### Real-Time Bolus Lookup Query Function

Referring to FIG. 6, when the user has decided to initiate a bolus delivery routine, in one embodiment, the user activates the pump user interface(or the user interface on the blood glucose meter, or the receiver unit of the analyte monitoring system, for example) and select the bolus delivery feature. For example, the user enters the anticipated carbohydrate intake (3000) and/or the current glucose level (4000) and the processor looks up in the appropriate tables (3001 and 4001) the amount of insulin to be delivered. The resulting insulin amount(s) are displayed to the user and the user can then a) initiate delivery of the retrieved bolus, b) adjust the amount and then initiate delivery, or c) clear the user interface without initiating the retrieved bolus delivery.

In another aspect, the “current glucose” value may be automatically entered by the processor or other device, such as an integrated blood glucose meter or analyte monitoring device.

### Bolus Lookup Example

Using the example tables described above, if the user enters an anticipated carbohydrate amount of 17 grams, the processor looks up 17 grams in the food bolus lookup table and then displays on the user interface the corresponding retrieved 1.42 Units of insulin for the food bolus.

| | Carbs | Food Bolus |
|---|---|---|
| | 15 grams | 1.25 U |
| | 16 grams | 1.33 U |
| → | 17 grams | 1.42 U |
| | 18 grams | 1.50 U |
| | 19 grams | 1.58 U |
| | 20 grams | 1.67 U |

In the case where the user enters the current glucose level of, for example, 176 mg/dL. The processor looks up 176 mg/dL in the correction bolus lookup table and then the user interface displays or outputs 1.67 Units of insulin for the correction bolus.

| | Current Glucose | Correction Bolus |
|---|---|---|
| | 173 mg/dL | 1.60 U |
| | 174 mg/dL | 1.62 U |
| | 175 mg/dL | 1.64 U |
| → | 176 mg/dL | 1.67 U |
| | 177 mg/dL | 1.69 U |
| | 178 mg/dL | 1.71 U |

While specific embodiments are described above, within the scope of the present disclosure, the one or more look up tables stored and/or updated in the pump, analyte monitoring device, blood glucose meter, PC or other data processing terminals may include multiple arrays of fields and associated parameters, thus varying in size and entries depending upon the resolution of the associated data and values. With the decreasing cost of storage devices such as memory devices with a corresponding increase in the storage capacity, in one aspect, determination of appropriate bolus amount for administration by microprocessor based devices is provided without burdening the processor to perform the underlying calculation or determination of the corresponding bolus amount. Rather, a simple lookup data retrieval routine may be provided from the stored data and associated parameters.

Accordingly, a method in one aspect includes receiving a plurality of parameters associated with physiological therapy including medication dosage amount, each dosage amount associated with a predetermined subset of the plurality of parameters including one or more of a carbohydrate intake amount, a current glucose level information, a target glucose level information, insulin sensitivity information, a correction factor, or one or more combinations thereof, generating a matrix based on the received plurality of parameters, the matrix configured to define, at least in part, the relationship between one or more of the received plurality of parameters, and storing the matrix in a database as a look up table so that a medication dosage amount is retrieved based on a query function performed based on one or more of the stored plurality of parameters.

The plurality of parameters may include one or more of a time of day information associated with each of the one or more predetermined subset of the plurality of parameters, a physiological profile information associated with the physiological therapy, or time period information spanning the period of time for the received plurality of parameters, where the physiological profile information may include a diabetic condition of a patient, a biological condition of a patient, or a stress condition of the patient.

In one aspect, the method may include updating the stored matrix based on administered medication dosage amount, and further, where updating the stored matrix may include detecting the execution of the medication dosage amount, and storing, in the matrix, one or more of the parameters associated with the executed medication dosage amount, and the executed medication dosage amount.

The plurality of parameters may include one or more of time of day information associated with the medication dosage amount, or the frequency of out of range glycemic level during a predetermined time period,

The medication dosage amount may include one or more of a carbohydrate bolus amount, a correction bolus amount, a combined carbohydrate and correction bolus amount, an extended bolus amount, or a temporary basal amount.

A device in accordance with another aspect of the present disclosure includes a processing unit, and a memory device operatively coupled to the processing unit, and including one or more routines stored in the memory device, which when, executed, is configure for receiving a plurality of parameters associated with physiological therapy including medication dosage amount, each dosage amount associated with a predetermined subset of the plurality of parameters including one or more of a carbohydrate intake amount, a current glucose level information, a target glucose level information, insulin sensitivity information, a correction factor, or one or more combinations thereof, generating a matrix based on the received plurality of parameters, the matrix configured to define, at least in part, the relationship between one or more of the received plurality of parameters, and storing the matrix in a database as a look up table so that a medication dosage amount is retrieved based on a query function performed based on one or more of the stored plurality of parameters.

The memory device may include one or more of a volatile memory, or a non-volatile memory.

The processing unit may include one or more of a microprocessor, an application specific integrated circuit, or a state machine.

The memory device and the processing unit may be provided in one or more of a mobile telephone, a personal digital assistant, an external infusion pump, a medication injection device, a continuous glucose monitoring device, a blood glucose meter, a pager, a data relay device, a cradle device, a personal computer, or a server terminal.

In another aspect, the device may include output unit operatively coupled to the processing unit to output a resulting value from the performed query function, where the output unit may include one or more of a visual display unit, an audible output unit, or a vibratory output unit.

The plurality of parameters in a further aspect may include one or more of a time of day information associated with each of the one or more predetermined subset of the plurality of parameters, a physiological profile information associated with the physiological therapy, or time period information spanning the period of time for the received plurality of parameters, where the physiological profile information may include a diabetic condition of a patient, a biological condition of a patient, or a stress condition of the patient.

In still another aspect, the processing unit may be configured to update the stored matrix based on administered medication dosage amount.

Further, the processing unit may be configured to detect the execution of the medication dosage amount, and store in the memory device one or more of the parameters associated with the executed medication dosage amount, and the executed medication dosage amount.

In yet another aspect, the plurality of parameters may include one or more of time of day information associated with the medication dosage amount, or the frequency of out of range glycemic level during a predetermined time period, The medication dosage amount may include one or more of a carbohydrate bolus amount, a correction bolus amount, a combined carbohydrate and correction bolus amount, an extended bolus amount, or a temporary basal amount.

A method in still another aspect of the present disclosure includes receiving one or more of a carbohydrate amount or a blood glucose information, performing a query function to retrieve from a pre-stored lookup table an insulin dosage amount associated with the received one or more of the carbohydrate amount or blood glucose information, and outputting the retrieved insulin dosage amount.

Various other modifications and alterations in the structure and method of operation of this disclosure will be apparent to those skilled in the art without departing from the scope and spirit of the disclosure. Although the disclosure has been described in connection with specific preferred embodiments, it should be understood that the disclosure as claimed should not be unduly limited to such specific embodiments. It is intended that the following claims define the scope of the present disclosure and that structures and methods within the scope of these claims and their equivalents be covered thereby.

What is claimed is:

1. A method, comprising:
receiving a plurality of parameters associated with physiological therapy including medication dosage amount, each dosage amount associated with a predetermined subset of the plurality of parameters including one or more of a carbohydrate intake amount, a current glucose level information, a target glucose level information, insulin sensitivity information, a correction factor, or one or more combinations thereof;
generating a matrix based on the received plurality of parameters, the matrix configured to define, at least in part, the relationship between one or more of the received plurality of parameters;
storing the matrix in a database as a look up table so that a medication dosage amount is retrieved based on a query function performed based on one or more of the stored plurality of parameters.

2. The method of claim 1 wherein the plurality of parameters includes one or more of a time of day information associated with each of the one or more predetermined subset of the plurality of parameters, a physiological profile information associated with the physiological therapy, or time period information spanning the period of time for the received plurality of parameters.

3. The method of claim 2 wherein the physiological profile information includes a diabetic condition of a patient, a biological condition of a patient, or a stress condition of the patient.

4. The method of claim 1 including updating the stored matrix based on administered medication dosage amount.

5. The method of claim 4 wherein updating the stored matrix includes:
detecting the execution of the medication dosage amount; and
storing, in the matrix, one or more of the parameters associated with the executed medication dosage amount, and the executed medication dosage amount.

6. The method of claim 1 wherein the plurality of parameters includes one or more of time of day information associated with the medication dosage amount, or the frequency of out of range glycemic level during a predetermined time period,

7. The method of claim 1 wherein the medication dosage amount includes one or more of a carbohydrate bolus amount, a correction bolus amount, a combined carbohydrate and correction bolus amount, an extended bolus amount, or a temporary basal amount.

8. A device, comprising:
a processing unit; and
a memory device operatively coupled to the processing unit, and including one or more routines stored in the memory device, which when, executed, is configure for receiving a plurality of parameters associated with physiological therapy including medication dosage amount, each dosage amount associated with a predetermined subset of the plurality of parameters including one or more of a carbohydrate intake amount, a current glucose level information, a target glucose level information, insulin sensitivity information, a correction factor, or one or more combinations thereof, generating a matrix based on the received plurality of parameters, the matrix configured to define, at least in part, the relationship between one or more of the received plurality of parameters, and storing the matrix in a database as a look up table so that a medication dosage amount is retrieved based on a query function performed based on one or more of the stored plurality of parameters.

9. The device of claim 8 wherein the memory device includes one or more of a volatile memory, or a non-volatile memory.

10. The device of claim 8 wherein the processing unit includes one or more of a microprocessor, an application specific integrated circuit, or a state machine.

11. The device of claim 8 wherein the memory device and the processing unit are provided in one or more of a mobile telephone, a personal digital assistant, an external infusion pump, a medication injection device, a continuous glucose monitoring device, a blood glucose meter, a pager, a data relay device, a cradle device, a personal computer, or a server terminal.

12. The device of claim 8 further including an output unit operatively coupled to the processing unit to output a resulting value from the performed query function.

13. The device of claim 12 wherein the output unit includes one or more of a visual display unit, an audible output unit, or a vibratory output unit.

14. The device of claim 8 wherein the plurality of parameters includes one or more of a time of day information associated with each of the one or more predetermined subset of the plurality of parameters, a physiological profile information associated with the physiological therapy, or time period information spanning the period of time for the received plurality of parameters.

15. The device of claim 14 wherein the physiological profile information includes a diabetic condition of a patient, a biological condition of a patient, or a stress condition of the patient.

16. The device of claim 8 wherein the processing unit is configured to update the stored matrix based on administered medication dosage amount.

17. The device of claim 8 wherein the processing unit is configured to detect the execution of the medication dosage amount, and store in the memory device one or more of the parameters associated with the executed medication dosage amount, and the executed medication dosage amount.

18. The device of claim 8 wherein the plurality of parameters includes one or more of time of day information associated with the medication dosage amount, or the frequency of out of range glycemic level during a predetermined time period,

19. The device of claim 8 wherein the medication dosage amount includes one or more of a carbohydrate bolus amount, a correction bolus amount, a combined carbohydrate and correction bolus amount, an extended bolus amount, or a temporary basal amount.

20. A method, comprising:
receiving one or more of a carbohydrate amount or a blood glucose information;
performing a query function to retrieve from a pre-stored lookup table an insulin dosage amount associated with the received one or more of the carbohydrate amount or blood glucose information; and
outputting the retrieved insulin dosage amount.
